(19) United States
(12) Patent Application Publication
(10) Pub. No.: US 2009/0251579 A1
(43) Pub. Date: Oct. 8, 2009

(54) Image Sensor Circuit

(76) Inventors: Olaf Schrey, Ratingen (DE); Werner Brockherde, Duisburg (DE); Bedrich Hosticka, Muehlheim an der Ruhr (DE)

Correspondence Address: Thomson Licensing LLC, P.O. Box 5312, Two Independence Way, PRINCETON, NJ, 08543-5312, US

(21) Appl. No.: 12/227,668

(22) PCT Filed: May 22, 2007
(86) PCT No.: PCT/EP2007/054971

§ 371 Date: Nov. 24, 2008

(30) Foreign Application Priority Data
May 23, 2006 (EP) 06300511.0

(51) Int. Cl. H04N 5/335

(52) U.S. Cl. 348/308; 348/E05.091

(57) ABSTRACT

An image sensor circuit includes a CMOS image sensor with light sensitive pixels arranged in rows and columns and a readout circuitry. The readout circuitry includes storage means with a CDS stage for storing signals read out from the pixels at two different time instants between two subsequent reset phases and an analogue-to-digital converter, wherein the CDS stage comprises a subtracting means for subtracting the stored signals from each other and wherein the result of the subtraction is fed to the analogue-to-digital converter as a differential signal.

### BACKGROUND OF THE INVENTION

1. Field of the Invention

The present invention is related to an image sensor including a CMOS image sensor with light sensitive pixels arranged in rows and columns and a readout circuitry.

Only recently CMOS image sensors are beginning to enter the field of professional cameras, for example cameras for TV productions or movie productions. Until then those cameras were equipped with CCD image sensors. CMOS image sensors offer a higher readout speed when compared with CCD image sensors. However, until recently it was not possible to achieve the same high number of pixels in a CMOS image sensor as could be produced with CCD image sensors. The resulting resolution of CMOS image sensors was too low for professional cameras. Today's manufacturing techniques are capable of producing CMOS image sensors having similar numbers of pixels as CCD image sensors.

CMOS image sensors can be produced at lower costs than CCD image sensors. Further, CMOS image sensors can achieve higher frame rates due to the higher readout speed that can be achieved. Yet further the noise of CMOS image sensors is equal or less than the noise of CCD image sensors. Images taken with CMOS image sensors appear crisper, brilliant, and, due to the higher readout speed, fast movements do not appear smeared. Another advantage of CMOS image sensors is the possibility to integrate other circuitry on the sensor using the same technology.

2. Description of the Prior Art

In the U.S. Pat. No. 5,742,042 B1 a photodiode sensor circuit is described, wherein a readout circuitry includes a correlated double sampling circuit, i.e. a CDS circuit, for elimination of pattern noise. The CDS circuit comprises a capacitor, a clamping transistor and a transfer gate.

A circuit diagram with a CMOS image sensor circuit and a CDS circuit is described in the U.S. Pat. No. 5,969,758 B1. In the CDS circuit only switched capacitors are used. In an additional CDS circuit described in the U.S. Pat. No. 6,320,616 B1 capacitors with accompanying switches are used.

### SUMMARY OF THE INVENTION

It is desirable to provide an image sensor circuit with a readout circuitry for a CMOS image sensor capable of high readout speed. It is also desirable to provide a readout circuitry for a CMOS image sensor allowing for a high number of pixels to be addressed. It is yet desirable to provide a readout circuitry for a CMOS image sensor having a low noise figure.

The invention suggests an image sensor circuit with a readout circuitry as claimed in claim 1. Advantageous developments and embodiments of the invention are presented in the dependent claims.

According to the invention, an image sensor circuit includes a CMOS image sensor with light sensitive pixels arranged in rows and columns and a readout circuitry, wherein the readout circuitry itself includes storage means with a CDS stage for storing signals read out from the pixels at two different time instants between two subsequent reset phases and an analogue-to-digital converter. The CDS stage comprises a subtracting means for subtracting the stored signals from each other, wherein the result of the subtraction is fed to the analogue-to-digital converter as a differential signal. The CDS stage and the analogue-to-digital converter are generated as differential CDS stage with a differential output signal and as a differential analogue-to-digital converter for converting the differential signal.

The balanced or differential design provides a good rejection of crosstalk, common mode offsets. In particular, crosstalk of clock signals is reduced.

Preferably, the differential signal is fed from the CDS stage to the analogue-to-digital converter via a differential buffer stage. The differential buffer stage is used in order to decouple the CDS stage from the analogue-to-digital conversion stage and, as a result, to allow for high clock rates of the analogue-to-digital converter, corresponding to a high pixel rate and thus a high frame rate.

In one embodiment the differential buffer stage comprises transistors in a source follower configuration.

In another embodiment the differential buffer stage comprises single-ended operational amplifiers. Preferably, the differential buffer stage is provided with two buffer circuits, wherein each buffer circuit comprises a single-ended operational amplifier for one of two parts of the differential signal.

Preferably, the subtracting means comprises an amplifier, which is arranged in a switched capacitor amplifier configuration

In a development of the invention the CDS stage is provided with a common mode rejection stage. The CDS stage and the common mode rejection stage preferably provide a linear signal characteristic. Preferably, the common mode rejection stage is dynamically controlled.

In one embodiment of the invention the common mode rejection stage comprises common mode feedback control circuits for controlling the common mode operation point. Preferably, the common mode feedback control circuits are capacitively coupled.

### BRIEF DESCRIPTION OF THE DRAWINGS

The invention will be explained in more detail using one embodiment, illustrated in the figures.

It shows:

FIG. 1 an exemplary block diagram of an image sensor circuit with a readout circuitry of the invention;

FIG. 2 an exemplary circuit of a CDS stage;

FIG. 3 an exemplary circuit of a differential buffer stage; and

FIG. 4 an exemplary structure of the readout circuitry showing a signal path.

### DETAILED DESCRIPTION OF THE INVENTION

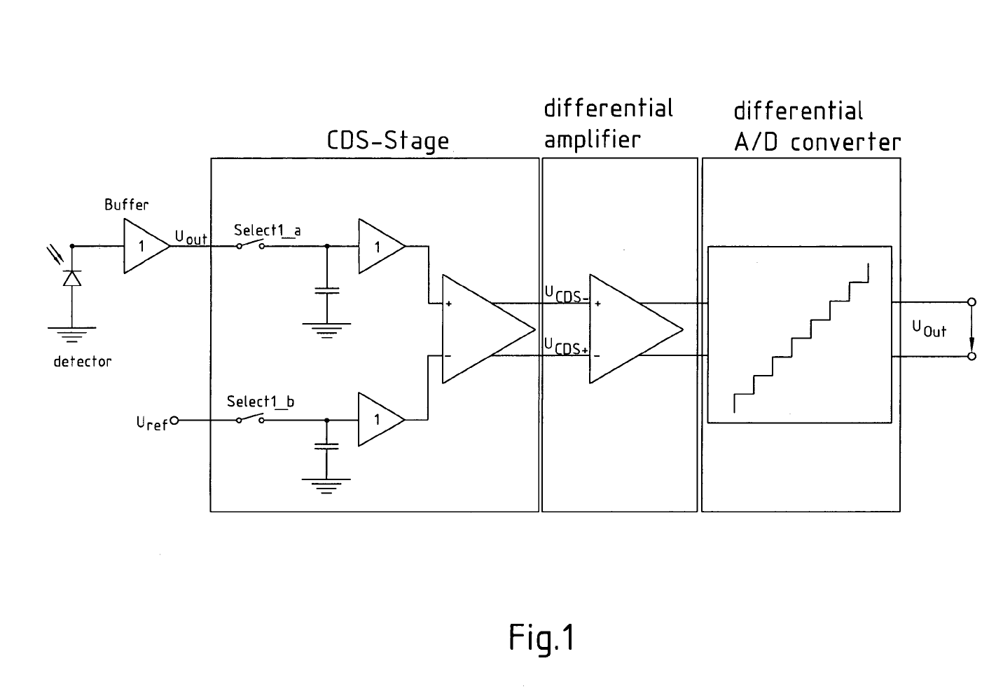

FIG. 1 shows an exemplary block diagram of an image sensor circuit including a CMOS image sensor with light sensitive pixels arranged in rows and columns and a readout circuitry according to the invention. The readout circuitry includes storage means with a differential CDS stage for storing signals read out from the pixels at two different time instants between two subsequent reset phases, a differential buffer stage and a differential analogue-to-digital converter. The CDS stage comprises a subtracting means for subtracting the stored signals from each other, wherein the result of the subtraction is fed to the analogue-to-digital converter as a differential signal via the differential buffer stage. The subtracting means comprises a differential amplifier.

In particular, the CDS stage performs a correlated double sampling in the analogue domain. An initial signal, also referred to as dark value is stored in a first capacitor. In the figure, the initial value is denominated Uref. A signal corresponding to the light integrated in a pixel during exposure after reset of the pixel is stored in a second capacitor. This signal is also referred to as bright value and is denominated Uₒᵤₜ. The differential amplifier subtracts the bright value from the dark value and outputs the result of the subtraction as U_{CDS+} and U_{CDS-} to a differential driver or buffer stage. The differential analogue-to-digital converter is connected to the output of the differential buffer stage.

As a result, the CDS stage is decoupled from the analogue-to-digital conversion stage by the differential buffer stage. The decoupling allows for high clock rates of the analogue-to-digital converter corresponding to a high pixel rate and thus a high frame rate. The differential buffer stage comprises at least one single-ended operational amplifier.

During operation at first a reference value or dark value is stored. The dark value can be the reset value of the image sensor or can be fed to the circuit externally. Thereafter the image sensor is exposed. The signal from the exposed image sensor or bright value is also stored. The stored values are subtracted from each other in the CDS stage. Subtraction can be performed, e.g. by a differential amplifier. In a preferred embodiment the reset value of the CMOS image sensor is used as the dark value. Depending on the CMOS sensor circuitry it may be necessary to store the reset value in an additional storage means, for example a capacitor. The calculated difference value may be amplified or buffered in the CDS stage. In the case of high numbers of pixels to be read the required bandwidth of the readout circuit can be very high. The same applies to the output of the CDS stage, in case it is also used as a buffer. Since a certain time is required in the CDS stage for the signals and transients to settle as well as to ensure a required minimum dynamic the bandwidth of the CDS stage is set to a predetermined value.

As an example, in order to provide a pixel signal having an 8-bit resolution the CDS stage must provide a useful dynamic range of 8 bit*6 dB/bit=48 dB at the desired operating frequency. Typically, amplifiers exhibit a relationship between gain and bandwidth which has to be considered. In order to determine the 3 dB roll off frequency the following equation can be used:

2*π*GBW=v*f_{—}3 dB,

wherein v corresponds to the gain, f_{—}3 dB is the 3 dB roll off frequency and GBW is the gain-bandwidth product of the amplifier. The required game-bandwidth product is determined by the pixel clock. For an image sensor having 1480 by 1920 pixels and a frame rate of 100 Hz the required gain-bandwidth product can be calculated as GBW=100 Hz*1480*1920=284 MHz. In order to provide enough dynamic for later image processing a resolution of 12 bit or 16 bit is desired. The gain of the amplifier can then be calculated as:

$$v = {10}^{\frac{12 bit \cdot 6 dB / bit}{20 dB}} = 3981.$$

The 3 dB roll off frequency of the CDS stage amplifier can then be calculated as:

$${f}_{3 dB} = \frac{2 \cdot π \cdot GBW}{v} = 448 kHZ .$$

At the same time the noise of the CDS stage must not be higher than allowed for the required dynamic range, in this example 72 dB or 12 bit. Analog circuits in CMOS process technology having structural sizes equal to or smaller than 0.5 μm and 3.3 V supply voltage allow for a useful signal swing of 1.8 V. Given these values the maximum noise allowed for the amplifier can be estimated as follows:

$$DR = 20 dB \cdot log ( \frac{{V}_{max}}{\sqrt{{v}_{n}^{2}}} ) ,$$

wherein DR is the dynamic range, in this case 72 dB, determined by the desired resolution. Vₘₐₓ is the maximum useful signal swing, in this case 1.8 V and Vₙ is the equivalent noise voltage. Solving this equation for the noise results in a maximum admissible equivalent noise voltage of vₙ=140 μV. A typical operational amplifier having a 3 dB roll off frequency of 448 kHz does not comply with these requirements. The maximum admissible equivalent noise voltage of 140 μV corresponds to an equivalent noise power of 19.5 nV². Noise powers of this magnitude would reduce the sensitivity of a pixel in such a way that dark areas of an image would not contain any useful information. The requirements as to sensitivity and speed set out by professional cameras can, therefore, not be fulfilled by a readout circuitry based on known, single CDS stages.

As mentioned above, according to the invention the readout circuitry is provided with a differential design. In particular, the differential buffer stage is provided between the differential CDS stage and the differential analogue-to-digital conversion stage. This differential buffer stage reduces the bandwidth requirements of the CDS stage amplifier and hence reduces the noise of the amplifier. The subtraction and high precision amplification is performed in the CDS stage. The differential buffer stage is provided for the high-speed transmission of the so-treated signal to the analogue-to-digital converter. It goes without saying that the noise added by the differential buffer stage must be lower than the reduction of the noise in the CDS stage by reducing the gain-bandwidth requirements of the CDS stage.

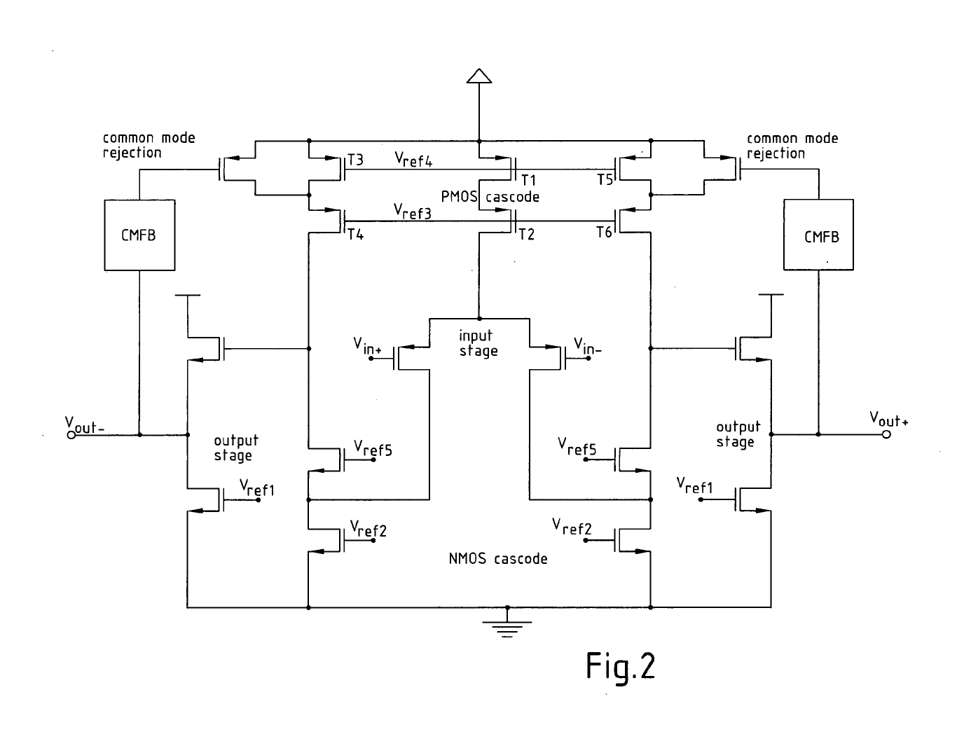

In FIG. 2 an exemplary circuit of a differential CDS amplifier will be described. The exemplary circuit shown in the FIG. 2 is supplemented by an output stage further increasing the open loop gain and thereby the accuracy of the CDS amplifier. The exemplary circuit shown in the figure allows for amplifier designs having an open loop gain of more than 100 dB and being suitable for applications requiring 16 bit resolution. Reference voltages V_ref1 to V_ref5 are supplied to the circuit via a reference voltage network. In the figure the reference voltages are generated and distributed by transistors T3, T4, T5 and T6 in a current mirror configuration to cascode-connected transistors T1 and T2.

The CDS stage is provided with a common mode rejection stage, wherein the CDS stage and the common mode rejection stage provide a linear signal characteristic. To this end, the common mode rejection stage is dynamically controlled.

In particular, the common mode rejection stage comprises common mode feedback control circuits CMFB, which are provided for controlling the common mode operating point. In one embodiment the common mode feedback control is capacitively coupled. The input stage of the CDS amplifier has a positive and a negative input Vin+ and Vin−. The positive and the negative inputs Vin+ and Vin− are connected to respective outputs of the imager providing the dark and the bright values (not shown). A capacitive coupling network (not shown) may be provided for connecting the outputs of the CDS amplifier Vout+ and Vout− to the input of the subsequent differential buffer stage (not shown). Offset compensation and subtraction are performed between the inputs and the outputs of the CDS amplifier. It is important that the CDS amplifier stage provides low-noise operation. Consequently, offset compensation and subtraction are performed at a lower speed.

In order to transfer the signals acquired in the CDS stage to the analogue-to-digital converter the differential buffer or driver stage is provided.

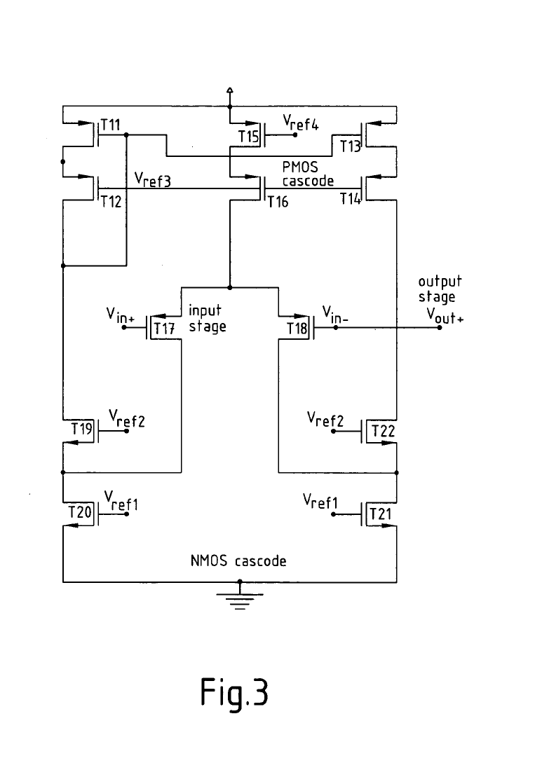

FIG. 3 shows an exemplary buffer circuit of the differential buffer stage in accordance with the invention. The buffer circuit shown in the figure is provided twice for each output of the CDS stage, i.e. for each of the two parts of the differential signal. The respective inputs Vin+ of the two buffer circuits are connected to respective outputs Vout+, Vout− of the CDS amplifier. The positive outputs Vout+ of the two buffer circuits are connected to the respective inputs of the differential analogue-to-digital converter. Depending on the design of the imager, i.e. of the CMOS image sensor, a varying number of CDS amplifiers and buffer stages can be provided on the imager chip. It is also possible to couple a number of CDS amplifiers to the imager via a bus-system. In this case a decoder and address network is provided for addressing the pixels of the imager. The latter case requires higher bandwidth and higher speed in the CDS stage. The maximum possible reduction in the bandwidth of the CDS stage and hence the maximum possible reduction of the noise in the CDS stage is achieved by combining each CDS stage with an associated driver or buffer stage. However, an increased power consumption may be contemplated in this case. In order to reduce the power consumption mixed architectures may be preferred.

In the exemplary buffer circuit transistors T17 and T18 form a differential amplifier. T15 and T16 are arranged in the common current path of the differential amplifier and set the operating current. Transistors T11, T12 and T13, T14 are arranged in respective cascode configurations with Vref3 being the fixed potential at the gate electrodes of T12, T14 and T16. Transistors T19, T20 and T21, T22 form respective cascodes that are connected with the drain electrodes of transistors T17 and T18. The control electrodes of transistors T19, T22 and T20, T21 are connected to respective reference potentials Vref2, Vref1. The control electrode of T18, representing the negative input Vin−, is connected to the output of the buffer stage.

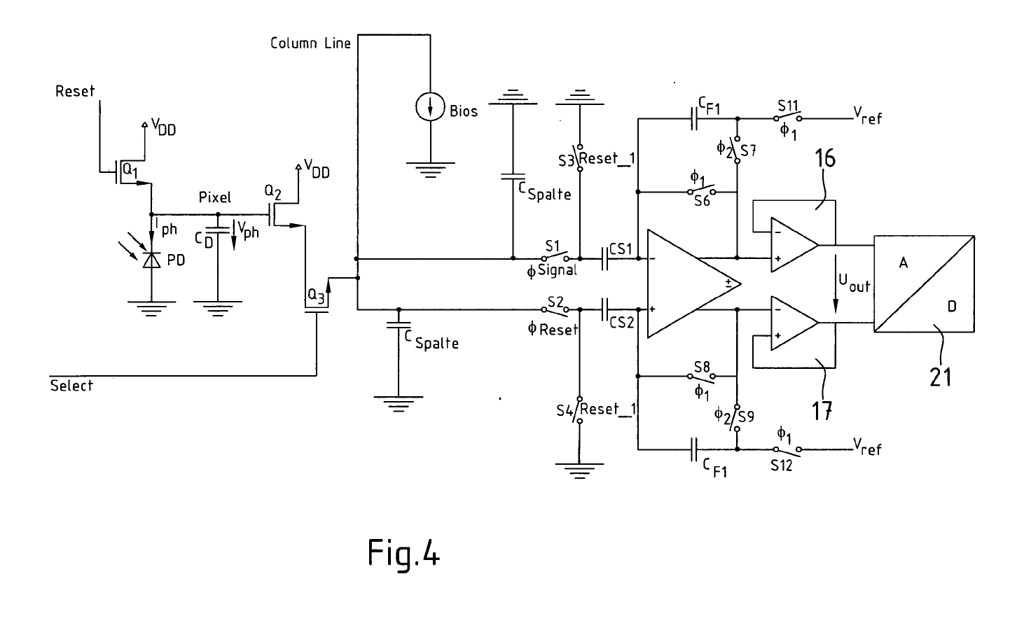

FIG. 4 shows an exemplary structure of a signal path of an image sensor circuit according to the invention. In the figure, a basic pixel circuit including a photodiode PD, a reset transistor Q1, a capacitance CD, a source follower Q2 and a selector switch Q3 are shown. This basic pixel circuit is known from the prior art. The basic pixel circuit is connected to a column line via the selector switch Q3. Parasitic capacitances of the column lines are shown as Cspaite in the figure. Switches S1, S2 are provided for applying the signal read out from the basic pixel circuit to respective storage or sample capacitances CS1, CS2. The storage or sample capacitances CS1, CS2 can be reset by respective switches S3, S4. The CDS amplifier shown in FIG. 2 is arranged in this figure in a switched capacitor amplifier configuration including switches S6. S7, S8, S9, S11 and S12 and capacitors CF1, CF2. Buffer circuits 16, 17 as presented in FIG. 3, provide buffering for the respective positive and negative output of the CDS amplifier. The buffer stages couple the differential signal coming from the CDS amplifier to a differential analogue-to-digital converter 21.

In the table below, figures for noise, power consumption and a maximum resolution are given for an exemplary readout circuit according to the invention. The resolution of a CDS stage is generally expressed in terms of noise equivalent electrons. The capacitance of the image detector, for example of the blocking capacitance of the photodiode, must be known for the calculations. The figures are given for an imager produced in a 0.35 μm 3.3 V CMOS process. Further key figures of the elements are given below:

Capacitance of the image detector CD=2.0 fF

Sample capacitance of the CDS stage=512 fF

Feedback capacitance of the CDS stage=256 fF

Capacitive load at AD converter input=2 pF

Frame rate=100 Hz

Number of pixels in the imager=1480×1920

Number of read out channels=32

| | CDS stage without | CDS stage with |
|---|---|---|
| | differential buffer | differential |
| Parameter | (prior art) | buffer stage |
| Power consumption (one | 10 mW | 36 mW |
| read-out channel) | | |
| Equivalent noise | 11.5 | 4.3 |
| electrons (CDS stage + | | |
| buffer stage) | | |
| Maximum resolution | 10 bit, limited by | 16 bit |
| | accuracy of settling | |

The figures in the table are given for a worst case signal, in which a full black and a full white pixel following each other are assumed. In the case of a monotonous grey-to-grey transition the noise values will be reduced.

The circuit according to the invention advantageously reduces the noise created in the CDS stage. Further, the bandwidth of the readout circuit is increased, thereby allowing for higher frame rates and/or numbers of pixels. The reduced noise allows for creating sensor arrangements having a higher number of pixels and a high dynamic range. The improved sensor arrangements, i.e. the improved image sensor circuits, may be used for high definition TV as well as for professional cinematographic filming. Further fields of applications include automotive, surveillance and medical applications in which high resolution and high-speed image capturing is required.

1. An image sensor circuit including a CMOS image sensor with light sensitive pixels arranged in rows and columns and a readout circuitry, wherein the readout circuitry which includes storage means with a CDS stage for storing signals read out from the pixels at two different time instants between two subsequent reset phases and an analogue-to-digital converter, wherein the CDS stage comprises a subtracting means for subtracting the stored signals from each other, characterised in that the output of the CDS stage provides the result of the subtraction to the analogue-to-digital converter as a balanced signal.

2. The image sensor circuit of claim 1, wherein the balanced signal is fed from the CDS stage to the analogue-to-digital converter via a differential buffer stage.

3. The image sensor circuit of claim 2, wherein the differential buffer stage comprises transistors in a source follower configuration.

4. The image sensor circuit of claim 2, wherein the differential buffer stage comprises at least one single-ended operational amplifier.

5. The image sensor circuit of claim 4, wherein the differential buffer stage is provided with two buffer circuits, wherein each buffer circuit comprises a single-ended operational amplifier for one of two parts of the balanced signal.

6. The image sensor circuit of claim 1, wherein the subtracting means comprises an amplifier, which is arranged in a switched capacitor amplifier configuration.

7. The image sensor circuit of claim 1, wherein the CDS stage is provided with a common mode rejection stage.

8. The image sensor circuit of claim 7, wherein the common mode rejection stage is dynamically controlled.

9. The image sensor circuit of claim 7, wherein common mode rejection stage comprises common mode feedback control circuits for controlling the common mode operation point.

10. The image sensor circuit of claim 9, wherein the common mode feedback control circuits are capacitively coupled.
